(19) United States
(12) Patent Application Publication
(10) Pub. No.: US 2026/0354340 A1
(43) Pub. Date: Nov. 12, 2026

(54) Triple-use Scooper

(71) Applicant: Judith E. Bennett, Holyoke, MA (US)

(72) Inventor: Judith E. Bennett, Holyoke, MA (US)

(21) Appl. No.: 19/202,840

(22) Filed: May 8, 2025

(51) Int. Cl. A01K 1/01; A01B 1/02

(52) U.S. Cl. CPC A01K 1/0114; A01B 1/02

(57) ABSTRACT

The present invention is a triple-use scooping tool designed for handling solid, semi-solid, and granulated materials. The tool features a forward scraping edge for removing dried material from hard surfaces, a slotted section for sifting larger or semi-solid particles, and an un-slotted front section for shoveling smaller particles and grains that cannot be sifted. This integrated configuration allows for efficient material management, in tasks such as pet litter cleaning, gardening, beach play, construction, and industrial applications.

The tool is durable and intended for repeated use across household and light industrial applications, reducing the need for multiple tools. By combining scraping, sifting, and shoveling in a single adaptable device, the invention offers practical versatility for managing a variety of materials in diverse environments.

### CROSS-REFERENCE TO RELATED APPLICATIONS

During my preliminary review, I identified a prior patent based on a similar premise. However, that patent disclosed a design more complicated than mine. My invention offers a simpler, and more efficient approach to addressing the same need. I also confirmed with the United States Patent and Trademark Office the referenced patent, which is more than 20 years old, is not active: US 2002/0149215 A1, Pub. Oct. 17, 2002, Inventor(s) McLaughlin, Philip Alan. A second patent, US-20230345902-A1, Pub. Nov. 2, 2023, Inventor Ekstein, SR., Joan, describes a scooping tool that lacks the front shovel area.

### BACKGROUND OF THE INVENTION

Current scooping tools used for separating and transferring granulated materials, such as pet waste from litter, typically rely on fully slotted designs. While these tools are effective in sifting out larger solid materials, they fail to address smaller, undesired particles—such as fine grains, small pebbles, or powder—that are too small to be sifted out through the slots. As a result, users must rely on additional tools or manual effort to remove these materials, leading to inefficiencies and increased time spent on the task.

Additionally, existing tools may not perform well when dried or stuck material needs to be scraped from hard surfaces, such as litter pans, requiring further manual intervention or the use of separate scraping tools and increasing the duration and frequency of unpleasant tasks such as pet waste management.

The present invention solves these issues by incorporating an un-slotted front edge of the scooping tool, which allows users to scrape up dried material, and shovel and remove smaller particles or unwanted material that cannot be sifted out through the slots. This enhancement provides greater versatility, eliminating the need for multiple tools and enabling users to efficiently handle materials of various sizes, from fine grains to larger solid objects.

### BRIEF SUMMARY OF INVENTION

The present invention relates to a versatile, triple-use scooping tool designed for the efficient removal, separation, and transfer of solid, semi-solid, or granulated materials. The tool integrates three distinct functions into a single, adaptable design:
1. A forward scraping edge for dislodging dried or adhered material from hard surfaces, such as litter pans.
2. A slotted sifting section for separating larger solids or semi-solids from finer material.
3. A front unslotted shovel area for collecting smaller particles, such as powders or fine grains, that otherwise would fall through the slotted surface.

This integrated configuration enables users to manage a variety of materials with differing consistencies, improving efficiency and eliminating the need for multiple tools. The invention is especially effective for tasks such as pet litter management but is adaptable to broader applications, including those involving coarse or fine particulate matter.

The tool's dimensions, structure, and materials may be modified without departing from the scope of the invention, allowing customization to suit various containers, environments, or material types.

### BRIEF DESCRIPTION OF DRAWING

FIG. 1 shows a line drawing of a triple-use scoop design, illustrating the handle, hanging hole, slotted sifting surface, front scraping edge, and front unslotted shovel area.

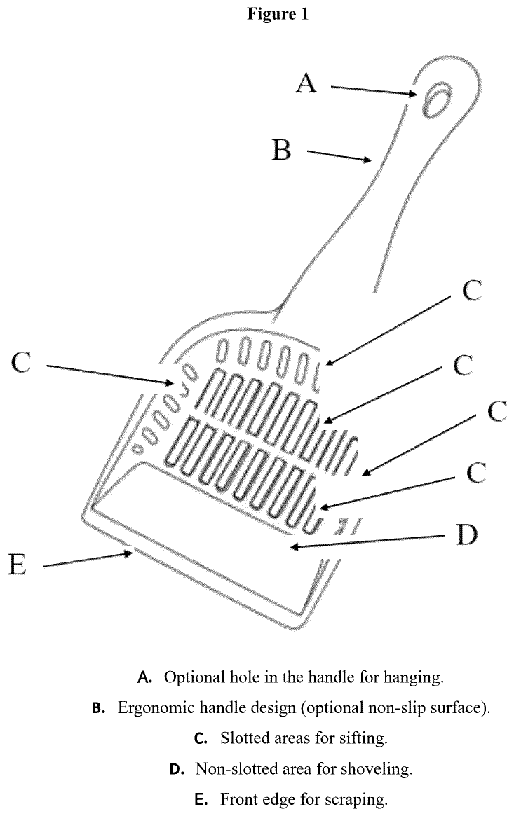

### DETAILED DESCRIPTION OF THE INVENTION

The present invention is a triple-use scooping tool designed to efficiently manage solid, semi-solid, and granulated materials. The tool is particularly useful in applications requiring the removal or transfer of materials with varying particle sizes, such as pet litter, powdered substances, or larger pebbles.

The tool consists of three main functional components (1-3 below):
1. Forward Scraping Edge: The front scraping edge of the tool is designed with a smooth, straight edge, allowing the user to scrape dried or hardened material from a flat or hard surface, such as the bottom of a litter pan or container.
2. Un-slotted Front Section: The un-slotted “shovel” portion of the scoop is specifically designed to scoop finer materials that cannot be sifted out through the slotted section. This feature allows for efficient removal of smaller particles, such as fine grains, powder, small pebbles, and litter granules. The size of the solid “shovel” area may vary for different uses.
3. Slotted Section: Behind the un-slotted front section, the slotted scoop section is equipped with slots or perforations. This section is designed to sift larger solid or semi-solid materials, allowing finer particles to fall through while retaining larger clumps or undesired solid matter. The size and shape of the slots can be varied depending on the specific application or material being managed, or designed with silhouettes such as animal shapes for decorative effect. For example, larger slots may be used for rougher materials, while smaller slots are ideal for fine particulate matter.
4. Handle: The tool features a handle designed for comfortable use. The handle may be constructed with an ergonomic shape to reduce hand fatigue during extended use. Additionally, it can be made with anti-slip material or texturing for better grip, particularly in wet or messy environments.
5. Hole for hanging. The tool features an optional hole at the end of the handle for hanging.

### Pet-Waste Scooping and Odor Reduction

The present invention is particularly useful for pet-waste scooping and sifting, especially when used with clumping litter.

When solid pet waste is scooped from the aggregate litter in a litter pan, the tool efficiently removes the waste while allowing clean granules to sift through the slotted section.

However, liquid waste, such as cat urine in clumping litter tends to saturate the granules and can lead to clumps breaking apart during removal and scraping from the litter pan. Because cat urine is highly odorous, it is important to remove as much of the saturated granules as possible to minimize lingering smells from the litter pan. The tool's design, including its un-slotted front edge, is effective in gathering and removing smaller, saturated granules that might sift back into a litter pan or break off during scraping or sifting.

Removing all saturated granules allows litter to last longer between emptying and refilling litter pans, helping to maintain a cleaner, fresher environment for both pets and owners.

### Materials and Construction

The tool can be constructed from a variety of materials, such as plastic, metal, or composite materials, depending on the intended use. For home applications, lightweight, durable plastic or metal may be preferred for ease of use and cleaning. In industrial settings, more robust materials like heavy metal or heavy-duty composites may be used to withstand harsher conditions.

The handle of the tool is ergonomically designed for comfortable use over extended periods and to minimize hand fatigue. It may also be constructed with an anti-slip coating or texturing for better handling in wet or messy environments.

The tool's handle includes an optional hole positioned near the end, designed to allow the tool to be hung for convenient storage. This feature adds practicality for users who prefer to store the tool by hanging it, either on a hook or a storage rack.

### Alternative Uses

While the primary application of the tool is for managing pet litter and other coarse granulated materials, its design may be adapted for additional uses in home, recreational, and industrial settings. These include:
Gardening and Composting: Sifting soil or compost to remove debris or separate materials.
Small-Scale Construction: Handling or sorting gravel, sand, or similar aggregates.
Food and Ingredient Management: In appropriate food-safe versions, the tool may help break up or sift out clumps in dry ingredients like flour or sugar, and remove larger food pieces from crumbs.
Recreational or Domestic Use: Locating lost items in sand or snow, using as a beach toy, or as a birdseed or pet food sifter, or crafting tool.
Workshop and Industrial Sorting: Separating small parts, sifting granulated materials, or scaling up for industrial processing needs.

These examples illustrate the tool's general adaptability across various material-handling tasks.

It should be noted that for hygiene and safety, distinct tools should be used for different contexts; for example, a tool used for litter management never would be appropriate for food handling or children's activities.

### Variations and Modifications

Various modifications to the design may be made without departing from the scope of the invention. The size and shape of the scoop can be adapted for different applications, ranging from small, handheld models for home use to larger, industrial-grade versions for handling bulk materials. The slotted section may also be configured with different slot patterns or adjustable slot dimensions to suit varying material types. The size of the shovel in relation to the slotted area also may be adjusted.

Modular components could be introduced to further customize the tool. For example, interchangeable scoop heads with varying front-edge profiles or slot configurations could enhance versatility, although such modifications are not part of the current embodiment.

1. A triple-use scooping tool for handling solid, semi-solid, and granulated materials, comprising:
A forward scraping edge configured to remove dried material from hard surfaces;
A slotted section configured to sift larger solid or semi-solid materials; and
An un-slotted front edge configured to shovel finer particles and undesired grains that cannot be sifted through the slotted section.

2. The tool of claim 1, wherein the tool is constructed from materials designed to withstand repeated scraping and scooping forces, ensuring durability and long-term use.

3. The tool of claim 1, further comprising an optional hole in the handle, configured to allow the tool to be hung for convenient storage.

4. The tool of claim 1, wherein the slotted section comprises slots of the same or varying size on the same tool to accommodate different particle sizes during a single use.

5. The tool of claim 1, wherein additional sizes and features, such as attachable scrapers, varying slot shapes, modular components, or different materials, may be considered to customize the tool for specific needs, though such modifications are not part of the present design.

6. The tool of claim 1, wherein the tool is made from plastic, metal, or composite materials, each chosen for its strength and resistance to wear under repeated use.

7. The tool of claim 1, wherein the handle is ergonomically shaped for user comfort during extended use.

8. The tool of claim 1, further comprising an optional anti-slip coating, texture, or finish on the handle to enhance grip in wet or messy environments.

9. The tool of claim 1, wherein the tool may be scaled for use in industrial applications, with a larger size and more durable material construction, suitable for heavy-duty usage.
